(19) United States
(12) Patent Application Publication
(10) Pub. No.: US 2006/0001607 A1
(43) Pub. Date: Jan. 5, 2006

(54) Plasma display apparatus and driving method thereof

(75) Inventors: Byung Soo Song, Goyang-si (KR); Tae Hyung Kim, Seoul (KR); Jung Hwan Kim, Seoul (KR); Hee Chan Yang, Suyeong-gu (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 11/171,478

(22) Filed: Jul. 1, 2005

(30) Foreign Application Priority Data
Jul. 2, 2004 (KR) 10-2004-0051746

(51) Int. Cl. G09G 3/28

(52) U.S. Cl. 345/63

(57) ABSTRACT

The present invention relates to a plasma display apparatus, and more particularly, to a plasma display apparatus and a driving method thereof, which is capable of preventing damage of a driving circuit. The plasma display apparatus according to the present invention includes a pattern recognition unit for recognizing an alternate pattern in which no less than a predetermined number of cells on the Nth line are turned on and no less than a predetermined number of cells on the N+1th line are turned off depending on an image signal input from the exterior; a sub-field mapping unit for mapping the image signal by the sub-field unit to a corresponding sub-field; and a controller for controlling a predetermined number of sub-fields among the whole sub-fields during one frame to be used when the pattern recognition unit recognizes the alternate pattern. In a plasma display apparatus and a driving method thereof according to the present invention, a predetermined number of sub-fields among the whole sub-fields are controlled to be used during one frame when an alternate pattern is recognized so that a generated peak current is reduced, thereby preventing damage of a sustain and a scan driving units.

This Nonprovisional application claims priority under 35 U.S.C. § 119(a) on Patent Application No. 2005-0051746, filed in Korea on Jul. 2, 2004 the entire contents of which are hereby incorporated by reference.

### BACKGROUND OF THE INVENTION

1. Field of the Invention

The present invention relates to a plasma display apparatus, and more particularly, to a plasma display apparatus and a driving method thereof, which are capable of preventing damage of a driving circuit.

2. Description of the Background Art

In general, a plasma display apparatus includes a plasma display panel having a front substrate and a rear substrate, and a barrier rib defining one unit cell therebetween. A main discharge gas such as neon (Ne), helium (He) or a combination of neon and helium (Ne+He) and an inert gas containing a small amount of xenon (Xe) are filled into each cell. When the inert gas is discharged due to a high frequency voltage, the inert gas generates vacuum ultraviolet rays and excites phosphor between the barrier ribs, thereby displaying an image. Since such a plasma display panel has a thin and light structure, the plasma display panel has been highlighted as a next generation display apparatus.

FIG. 1 is a perspective view illustrating a structure of a general plasma display panel.

As shown in FIG. 1, the plasma display panel includes a front substrate 100 on a side of which a plurality of a pair of sustain electrodes having a scan electrode 102 and a sustain electrode 103 being in pairs are arranged on a front glass 101 being a display side for displaying an image and a rear substrate 110 on a side of which a plurality of address electrodes 113 are arranged to intersect the pair of sustain electrodes on a rear glass 111 being the rear. The front panel 100 and the rear panel 110 are combined with each other at a predetermined interval therebetween.

The front substrate 100 includes a scan electrode 102 and a sustain electrode 103 being in pairs for mutually discharging and sustaining luminescence of a cell in the cell. Each of the scan electrode 102 and the sustain electrode 103 comprises a transparent electrode (a) made of a transparent ITO material and a bus electrode (b) made of a metallic material. One or more upper dielectric layer 104 are coated on the scan electrode 102 and the sustain electrode 103 to limit a discharge current and to insulate the pair of electrodes. Further, a protection layer 105 is formed on a top surface of the upper dielectric layer 104 to ease a discharge condition.

On the rear substrate 110, a plurality of discharge spaces, that is, stripe type (or well type) barrier ribs 112 are parallelly arranged to form a discharge cell. Further, a plurality of address electrodes 113 for performing address discharge are arranged in parallel to the barrier ribs 112. R, G, B phosphors 114 discharging visible rays are coated on an upper side of the rear substrate 110 to display an image when sustain discharge. A dielctric layer 115 is formed between the address electrodes 113 and the phosphors to protect the address electrodes 113.

FIG. 2 is a view illustrating a method of expressing an image in a conventional plasma display apparatus.

As shown in FIG. 2, in the plasma display apparatus, one frame is divided into several sub-fields each having a different number of discharge times. Further, light is emitted in a plasma display panel during a sub-field period corresponding to a gray level of an input image signal, thereby expressing an image.

Each of the sub-fields is divided into a reset period for uniformly generating discharge, an address period for selecting a discharge cell, and a sustain period for expressing the gray level depending on the number of discharge times. For example, in case that the image is displayed in 256 gray levels, a frame period (16.67 ms) corresponding to 1/60 second is divided into eight sub-fields (SF1 to SF8) as shown in FIG. 2.

Further, each of the eight sub-fields is again divided into a reset period, an address period and a sustain period. Here, the sustain period is increased in a ratio of 2ⁿ (n=0,1,2,3,4,5,6,7) in each sub-field. In this way, since the sustain periods are different in each of the sub-fields, the gray level can be expressed.

FIG. 3 is a schematic view illustrating a conventional plasma display apparatus.

As shown in FIG. 3, the conventional plasma display panel includes a plasma display panel 300, an image signal processor 310, a sub-field mapping unit 320, a data aligner 330, a data driving unit 340, a scan driving unit 350, a sustain driving unit 360 and a controller 370.

In the plasma display panel 300, there are fromed scan electrodes (Y₁ to Yₙ), sustain electrodes (Z) and a plurality of address electrodes (X₁ to Xₘ) intersecting the scan electrodes (Y₁ to Yₙ) and the sustain electrodes (Z).

The image signal processor 310 converts an image signal input from the exterior into an image signal for driving a plasma display apparatus. Such an image signal processor 310 includes an inverse gamma correcting unit (not shown) for inverse gamma correcting an image signal, a gain controller (not shown) for adjusting a gain value of an image signal and a half tone unit (not shown) for enhancing expression of a gray level.

The sub-field mapping unit 320 maps an image signal input from the image signal processor 310 by the sub-field unit to a corresponding sub-field.

The data aligner 330 realigns by the sub-field an image signal mapped as a sub-field unit by the sub-field mapping unit 320.

The data driving unit 340 applies an address pulse corresponding to the aligned image signal to the address electrodes (X₁ to Xₘ) formed in the plasma display panel 300.

The scan driving unit 350 drives the scan electrodes (Y₁ to Yₙ) formed in the plasma display panel 300. The scan driving unit 350 applies a setup pulse and a setdown pulse during a reset period, sequentially applies scan pulses during an address period, and applies sustain pulses during a sustain period.

The sustain driving unit 360 drives the sustain electrodes (Z) being common electrodes formed in the plasma display panel 300. The sustain driving unit 360 applies a positive bias pulse during an address period, and alternately applies at least one or more sustain pulses for performing sustain discharge with the scan pulses during a sustain period.

The controller 370 controls timing of each driving pulse applied to the data driving unit 340, the scan driving unit 350 and the sustain driving unit 360 during a reset, an address and a sustain periods. Further, the controller 370 controls image signals realigned by the data aligner 330 depending on an image signal input from the exterior to be sequentially read and then to be supplied by the quantity for a scan line to the data driving unit 340.

Meanwhile, there is a drawback in that each of the driving units 330, 340 and 350 is loaded in the conventional plasma display apparatus when a specific pattern is expressed in a picture. Particularly, circuit elements of the scan driving unit 350 and the sustain driving unit 360 are seriously damaged when an alternate pattern is expressed. Here, the alternate pattern means a picture in which a turned-on lines and turned-off lines are alternated. In case that an alternate pattern is sustained for approximately one minute, the sustain driving unit 360 is damaged, and generation of heat is deteriorated in the scan driving unit 350. The reason caused due to this will be described with reference to FIGS. 4 and 5.

FIG. 4 is a circuit diagram illustrating a plasma display apparatus in which a conventional alternate pattern is expressed, and FIG. 5 is a waveform diagram of an address pulse expressing a conventional alternate pattern.

Referring to FIGS. 4 and 5 together, a sustain driving unit 410 includes each switching element for supplying a pulse from a bias voltage source (V_{zb}) for supplying a bias pulse and a sustain voltage suource (Vₛ) for supplying a sustain pulse and an energy recovery circuit 413 for recovering or supplying energy when the sustain driving unit 410 is driven. Further, the scan driving unit 420 includes each switching element for supplying a setup pulse, a setdown pulse, a scan pulse and a sustain pulse and an energy recovery circuit (not shown).

Here, if an image signal corresponding to an alternate pattern is input to a plasma display apparatus, a high-level address pulse is applied to all the address electrodes when one line is scanned, and a low-level address pulse is applied to all the address electrodes when the next line is scanned.

In the sustain driving unit 410, as an address pulse is applied, a first peak current (Iₚ₁) and a second peak current (Iₚ₂) is flown due to a capacitance of a capacitor (C₁) formed between an address electrode (X) and a sustain electrode (Z). In other words, the first peak current (Iₚ₁) is generated when an address pulse applied from a low level to a high level is applied to an address electrode, and the second peak current (Iₚ₂) is generated when an address pulse applied from a high level to a low level is applied to an address electrode. At this time, there is a drawback in that the sustain driving unit 410 is damaged due to excessive generation of heat while the first peak current (Iₚ₁) and the second peak current (Iₚ₂) are flown through a first switch 411 and a scond switch 412 which are turned on during an address period.

In the scan driving unit 420, as an address pulse is applied, a third peak current (Iₚ₃) and a fourth peak current (Iₚ₄) is flown due to a capacitance of a capacitor (C₂) formed between an address electrode (X) and a sustain electrode (Z). In other words, the first peak current (Iₚ₃) is generated when an address pulse applied from a low level to a high level is applied to an address electrode, and the second peak current (Iₚ₄) is generated when an address pulse applied from a high level to a low level is applied to an address electrode. At this time, there is a drawback in that the sustain driving unit 420 is damaged due to excessive generation of heat while the first peak current (Iₚ₃) and the second peak current (Iₚ₄) are flown through a third switch 413 and a fourth switch 413 which are turned on during an address period.

### SUMMARY OF THE INVENTION

Accordingly, an object of the present invention is to solve at least the problems and disadvantages of the background art.

An object of the present invention is to provide a plasma display apparatus and a driving method thereof, which a data driving unit is controlled when an alternate pattern is expressed so that the number of switching times of address pulses is reduced, thereby preventing damage of a sustain and a scan driving units.

To achieve these and other advantages and in accordance with the purpose of the present invention, as embodied and broadly described, there is provided a plasma display apparatus in accordance with a first embodiemt of the present invention including: a pattern recognition unit for recognizing an alternate pattern in which no less than a predetermined number of cells on the Nth line are turned on and no less than a predetermined number of cells on the N+1th line are turned off depending on an image signal input from the exterior; a sub-field mapping unit for mapping the image signal by the sub-field unit to a corresponding sub-field; anda controller for controlling a predetermined number of sub-fields among the whole sub-fields during one frame to be used when the pattern recognition unit recognizes the alternate pattern.

In another aspect of a first embodiment of the present invention, there is provided a method of driving a plasma display apparatus including the steps of: recognizing an alternate pattern in which no less than a predetermined number of cells on the Nth line are turned on and no less than a predetermined number of cells on the N+1th line are turned off depending on an image signal input from the exterior; mapping the image signal by the sub-field unit to a corresponding sub-field; and controlling a predetermined number of sub-fields among the whole sub-fields during one frame to be used when the alternate pattern is recognized in the pattern recognition step.

In one aspect of a second embodiment of the present invention, there is provide a plasma display apparatus including: a sub-field mapping unit for mapping an image signal input from the exterior by the sub-field unit to a corresponding sub-field; a pattern recognition unit for recognizing an alternate pattern in which no less than a predetermined number of cells on the Nth line are turned on and no less than a predetermined number of cells on the N+1th line are turned off by comparing a mapping code of the mapped image signal; and a controller for controlling a predetermined number of sub-fields among the whole sub-fields during one frame to be used when the pattern recognition unit recognizes the alternate pattern.

In another aspect of a second embodiment of the present invention, there is provided a method of driving a plasma display apparatus including the steps of: mapping an image signal input from the exterior by the sub-field unit to a corresponding sub-field; recognizing an alternate pattern in which no less than a predetermined number of cells on the Nth line are turned on and no less than a predetermined number of cells on the N+1th line are turned off by comparing a mapping code of the mapped image signal; and controlling a predetermined number of sub-fields among the whole sub-fields during one frame to be used when the alternate pattern is recognized in the pattern recognition step.

In a plasma display apparatus and a driving method thereof according to the present invention, a predetermined number of sub-fields among the whole sub-fields are controlled to be used during one frame when an alternate pattern is recognized so that a generated peak current is reduced, thereby preventing damage of a sustain and a scan driving units.

### BRIEF DESCRIPTION OF THE DRAWINGS

The invention will be described in detail with reference to the following drawings in which like numerals refer to like elements.

FIG. 1 is a perspective view illustrating a structure of a general plasma display panel;

FIG. 2 is a view illustrating a method of expressing an image in a conventional plasma display panel;

FIG. 3 is a schematic view illustrating a conventional plasma display apparatus;

FIG. 4 is a circuit diagram illustrating a plasma display apparatus in which a conventional alternate pattern is expressed;

FIG. 5 is a waveform diagram of an address pulse expressing a conventional alternate pattern;

FIG. 6 is a schematic view illustrating a plasma display apparatus according to a first embodiment of the present invention;

FIG. 7 is a schematic block diagram illustrating a pattern recognition unit according to a first embodiment of the presnent invention;

FIG. 8 is a view illustrating an operating characteristic of a pattern recognition unit according to a first embodiment of the present invention;

FIG. 9 is a truth table illustrating a control operation of a contriler in a plasma display apparatus according to a first embodiment of the present invention;

FIG. 10 is a schematic view illustrating a plasma display apparatus according to a second embodiment of the present invention;

FIG. 11 is a schematic block diagram illustrating a pattern recognition unit according to a second embodiment of the present invention; and

FIG. 12 is a view illustrating an operation characteristic of a pattern recognition unit according to a second embodiment of the present invention.

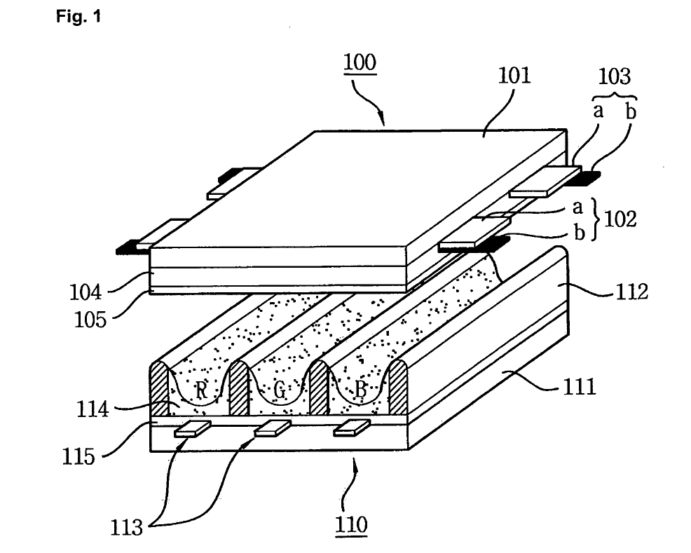

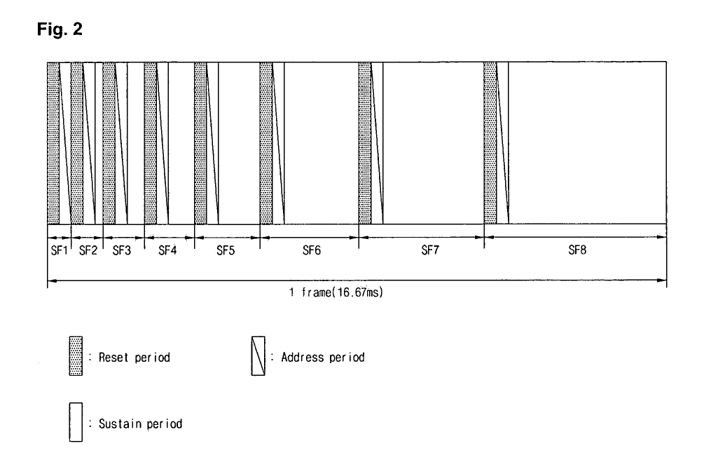

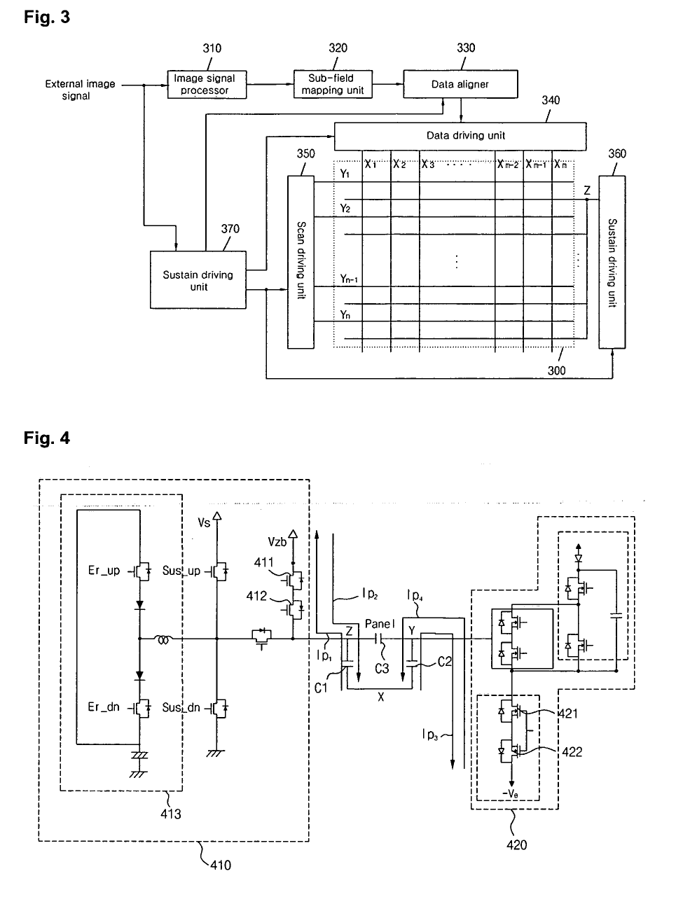

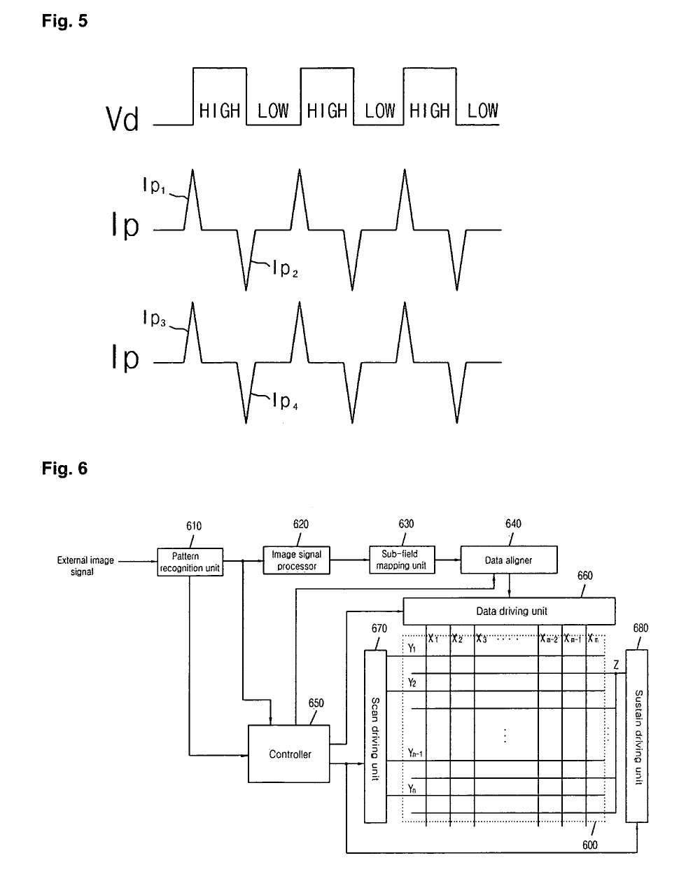

### DETAILED DESCRIPTION OF PREFERRED EMBODIMENTS

Preferred embodiments of the present invention will be described in a more detailed manner with reference to the drawings.

A plasma display apparatus according to a first embodiment of the present invention includes: a pattern recognition unit for recognizing an alternate pattern in which no less than a predetermined number of cells on the Nth line are turned on and no less than a predetermined number of cells on the N+1th line are turned off depending on an image signal input from the exterior; a sub-field mapping unit for mapping the image signal by the sub-field unit to a corresponding sub-field; and a controller for controlling a predetermined number of sub-fields among the whole sub-fields during one frame to be used when the pattern recognition unit recognizes the alternate pattern.

Preferably, the pattern recognition unit includes: a center cell setting unit for setting at least no less than two cells as center cells during one frame; a first threshold comparator for comparing a difference between a gray level value of the center cell and a gray level value of a cell adjacent thereto in a horizontal direction with a first threshold value; a second threshold comparator for comparing a difference between a gray level value of the center cell and a gray level value of a cell adjacent thereto in a vertical direction with a second threshold value; a third threshold comparator for evaluating the number of center cells which are less than the first threshold value and more than the second threshold value and comparing the number thereof with a third threshold value; and a pattern recognition information generator for determining an image signal of the frame as an alternate pattern and generating alternate pattern recognition information when the number of the center cells is more than the third threshold value.

Preferably, the first threshold value comparator compares gray level values of at least no less than two cells adjacent to the center cell as a cneter.

A plasma display apparatus according to a second embodiment of the present invention includes: a sub-field mapping unit for mapping an image signal input from the exterior by the sub-field unit to a corresponding sub-field; a pattern recognition unit for recognizing an alternate pattern in which no less than a predetermined number of cells on the Nth line are turned on and no less than a predetermined number of cells on the N+1th line are turned off by comparing a mapping code of the mapped image signal; and a controller for controlling a predetermined number of sub-fields among the whole sub-fields during one frame to be used when the alternate pattern is recognized in the pattern recognition step.

Preferably, the pattern recognition unit includes: a center cell setting unit for setting at least no less than two cells as center cells during one sub-field period; a first threshold comparator for comparing the number of cells having the same mapping codes as that of the center cell on the same line as that of the center cell with a first threshold value during the sub-field period; a second threshold comparator for comparing the number of cells having mapping codes different from that of the center cell on the next line of the center cell with a second threshold value during the sub-field period; a third threshold comparator for evaluating the number of center cells which are more than the first threshold value and the second threshold value and comparing the number thereof with a third threshold value; and a pattern recognition information generator for determining an image signal of the frame as an alternate pattern during one frame and generating alternate pattern recognition information when the number of the center cells is more than the third threshold value.

Preferably, the apparatus of the present invention further includes: a data aligner for realigning by the sub-field an image signal mapped to the sub-field; and a data driving unit for applying an address pulse corresponding to the aligned image signal to an address electrode under control of the controller.

Preferably, the controller controls sub-fields cut off when the alternate pattern is recognized to be selected, and controls a cutoff signal for turning off a switching element of the data driving unit during an address period of the selected sub-field to be applied to the data driving unit.

Preferably, the controller controls the sub-fields cut off not to be consecutive to each other.

Preferably, the controller controls the number of sustain pulses applied depending on sub-fields used during one frame.

A method of driving a plasma display apparatus according to a first embodiment of the present invention includes the steps of: recognizing an alternate pattern in which no less than a predetermined number of cells on the Nth line are turned on and no less than a predetermined number of cells on the N+1th line are turned off depending on an image signal input from the exterior; mapping the image signal by the sub-field unit to a corresponding sub-field; and controlling a predetermined number of sub-fields among the whole sub-fields during one frame to be used when the alternate pattern is recognized in the pattern recognition step.

Preferably, the pattern recognition step includes the steps of: setting at least no less than two cells as center cells during one frame; comparing a difference between a gray level value of the center cell and a gray level value of a cell adjacent thereto in a horizontal direction with a first threshold value; comparing a difference between a gray level value of the center cell and a gray level value of a cell adjacent thereto in a vertical direction with a second threshold value; evaluating the number of center cells which are less than the first threshold value and more than the second threshold value and comparing the number thereof with a third threshold value; and determining an image signal of the frame as an alternate pattern and generating alternate pattern recognition information when the number of the center cells is more than the third threshold value.

Preferably, gray level values of at least no less than two cells adjacent to the center cell as a cneter are compared in the first threshold value comparing step.

A method of driving a plasma display apparatus according to a second embodiment of the present invention includes the steps of: mapping an image signal input from the exterior by the sub-field unit to a corresponding sub-field; recognizing an alternate pattern in which no less than a predetermined number of cells on the Nth line are turned on and no less than a predetermined number of cells on the N+1th line are turned off by comparing a mapping code of the mapped image signal; and controlling a predetermined number of sub-fields among the whole sub-fields during one frame to be used when the pattern recognition unit recognizes the alternate pattern.

Preferably, the pattern recognition step includes the steps of: setting at least no less than two cells as center cells during one sub-field period; comparing the number of cells having the same mapping codes as that of the center cell on the same line as that of the center cell with a first threshold value during the sub-field period; comparing the number of cells having mapping codes different from that of the center cell on the next line of the center cell with a second threshold value during the sub-field period; evaluating the number of center cells which are more than the first threshold value and the second threshold value and comparing the number thereof with a third threshold value; and determining an image signal of the frame as an alternate pattern during one frame and generating alternate pattern recognition information when the number of the center cells is more than the third threshold value.

Preferably, the method of the present invention further includes the steps of: realigning by the sub-field an image signal mapped to the sub-field; and applying an address pulse corresponding to the aligned image signal to an address electrode under control of the controller.

Preferably, sub-fields cut off are selected when the alternate pattern is recognized, and a cutoff signal for turning off a switching element of the data driving unit during an address period of the selected sub-field is applied to the data driving step in the control step.

Preferably, the sub-fields cut off are not consecutive to each other in the control step.

Preferably, the number of sustain pulses applied depending on sub-fields used during one frame is controlled in the control step.

Hereinafter, preferred embodiments of the present invention will be described in a more detailed manner with reference to the drawings.

### FIRST EMBODIMENT

FIG. 6 is a schematic view illustrating a plasma display apparatus according to a first embodiment of the present invention.

As shown in FIG. 6, the plasma display apparatus according to the first embodiment of the present invention includes a plasma display panel 600, a pattern recognition unit 610, an image signal processor 620, a sub-field mapping unit 630, a data aligner 640, a controller 650, a data driving unit 660, a scan driving unit 670 and a sustain driving unit 680.

In the plasma display panel 600, there are fromed scan electrodes (Y₁ to Yₙ), sustain electrodes (Z) and a plurality of address electrodes (X₁ to Xₘ) intersecting the scan electrodes (Y₁ to Yₙ) and the sustain electrodes (Z).

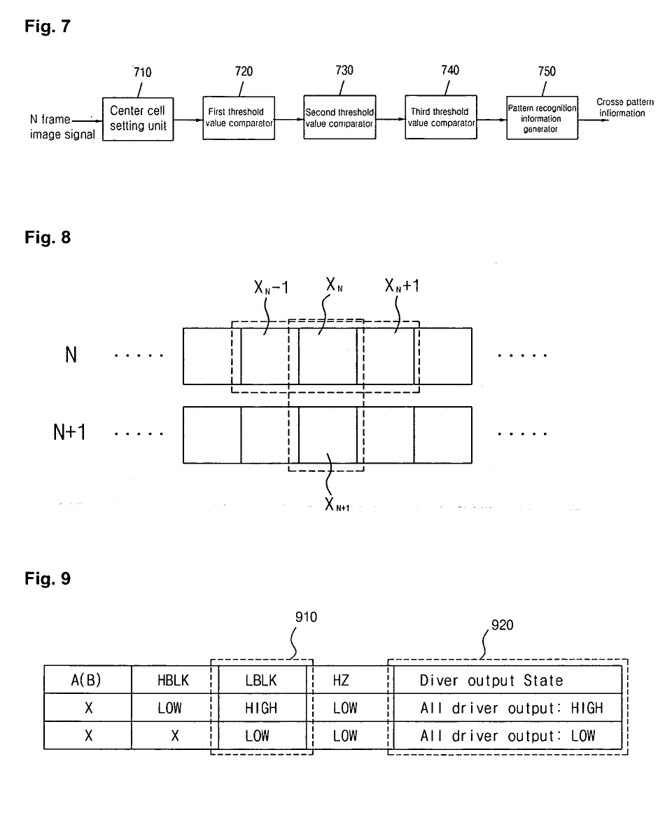

The pattern recognition unit 610 recognizes an alternate pattern in which no less than a predetermined number of cells on the Nth line are turned on, and no less than a predetermined number of cells on the N+1th line are turned off depending on an image signal input from the exterior. In other words, the pattern recognition unit 610 according to a first embedment of the present invention judges an image signal displayed as an alternate pattern by comparing gray level values of image signals assigned to each cell. To this end, the pattern recognition unit 610 sets a center cell and detects an alternate pattern by comparing a difference of the gray level values with a predetermined threshold value. This will be described in a more detailed manner with reference to FIGS. 7 and 8 hereafter.

The image signal processor 620 converts an exernal image signal input from the pattern recognition unit 610 into an image signal for driving a plasma display apparatus. Such an image signal processor 620 includes an inverse gamma correcting unit (not shown) for inverse gamma correcting an image signal, a gain controller (not shown) for adjusting a gain value of an image signal and a half tone unit (not shown) for enhancing expression of a gray level.

The sub-field mapping unit 630 maps an image signal input from the image signal processor 620 by the sub-field unit to a corresponding sub-field.

The data aligner 640 realigns by the sub-field an image signal mapped as a sub-field unit by the sub-field mapping unit 630.

The controller 650 controls timing of each driving pulse applied to the data driving unit 660, the scan driving unit 670 and the sustain driving unit 680 during a reset, an address and a sustain periods. Further, the controller 650 controls image signals realigned by the data aligner 640 depending on an image signal input from the exterior to be sequentially read and then to be supplied by the quantity for a scan line to the data driving unit 660.

The controller 650 according to the first embodiment of the present invention controls a predetermined number of sub-fields among the whole sub-fields to be used during one frame when the pattern recognition unit 610 recognizes an alternate pattern. First, an alternate pattern recognition information is transmitted from the pattern recognition unit 610 to the controller 650. Thereafter, the controller 650 selects sub-fields cut off among data of an image signal supplied by the quantity for a scan line to the data driving unit 660, and then applies a cutoff signal turning off an switching element of the data driving unit 660 to the data driving unit 660 druing an address period of the selected sub-fields. At this time, an address pulse is not applied to the whole picture due to the cutoff signal in the corresponding sub-field period. Accordingly, the numbers of switching times of a switching element is reduced, thereby decreasing a peak current.

Meanwhile, since an address pulse of the corresponding sub-fields is cut off, there is generated a pause period in which an image of the whole picture is not displayed in the sub-field period. If an address pulse is applied so that a picture is instantaneously displayed after such a pause period is sustained for no less than a predetermined period, there is generated a flicker. In consideration of this, the controller 650 controls sub-fields cut off to be consecutive to each other. In other words, the controller 650 controls a pause period to be sustained.

Further, the controller 650 according to an first embodiment of the present invention controls the number of sustain pulses applied depending on a combination of the rest of the sub-fields used during a frame to prevent an image displayed from being distorted due to sub-fields cut off. Thus, it is possible to prevent an image from being distorted when an alternate pattern is expressed.

The data driving unit 660 applies an address pulse corresponding to an image signal aligned by the data aligner 640 to address electrodes (X₁ to Xₘ) formed in the plasma display panel 600. At this time, predetermined sub-fields are cut off depnding on a cutoff signal of the foregoing controller 650 when an alternate pattern is expressed so that the number of switching times is reduced.

The scan driving unit 670 drives scan electrodes (Y₁ to Yₙ) formed in the plasma display panel 600. The scan driving unit 670 applies a setup pulse and a setdown pulse during a reset period, sequentially applies scan pulses during an address period, and applies sustain pulses during a sustain period. In the scan driving unit 670 according to a first embodiment of the present invention, a peak current generated during an address period is reduced as the number of switching times of the data driving unit 660 is decreased when an alternate pattern is expressed. Further, the scan driving unit 670 applies the number of sustain pulses controlled by the controller 650 during a sustain period of the used sub-fields.

The sustain driving unit 680 drives sustain electrodes (Z) being common electrodes formed in the plasma display panel 600. The sustain driving unit 680 applies a positive bias pulse during an address period, and applies a positive bias pulse during an address period, and alternately applies at least one or more sustain pulses for performing sustain discharge with the scan pulses during a sustain period. In the sustain driving unit 680 according to a first embodiment of the present invention, a peak current generated during an address period is reduced as the number of switching times of the data driving unit 660 is decreased when an alternate pattern is expressed. Further, the sustain driving unit 680 applies the number of sustain pulses controlled by the controller 650 during a sustain period of the used sub-fields. In such a plasma display apparatus according to a first embodiment of the present invention, a pattern recognition unit for recognizing an alterate pattern will be described in a more detailed manner with reference to FIGS. 7 and 8.

FIG. 7 is a schematic block diagram illustrating a pattern recognition unit according to a first embodiment of the presnent invention, and FIG. 8 is a view illustrating an operating characteristic of a pattern recognition unit according to a first embodiment of the present invention.

Referring to FIG. 7, The pattern recognition unit according to the first embodiment of the present invention includes a center cell setting unit 710, a first threshold value comparator 720, a second threshold value comparator 730, a third threshold value comparator 740 and a pattern recognition information generator 750. Referring to FIGS. 7 and 8 together, an operation of the pattern recognition unit will be described.

The center cell setting unit 710 sets at least no less than two cells as center cells during a frame. Arbitrary cells are set as center cells for the whole picture to detect an alternate pattern. In other words, a cell (X_{N}) on the Nth line is set as a center cell.

The first threshold value comparator 720 compares a difference between a gray level value of the set center cell and a gray level value of a cell that is adjacent thereto in a horizontal diriction with a first threshold value. At this time, it is preferred that the first threshold value comparator 720 compares a gray level value of the center cell (X_{N}) as a reference with gray level values of at least no less than two cells that are adjacent thereto in the horizontal direction to have a better reliability when an alternate pattern is detected. In other words, after the first threshold value comparator 720 evaluates differences between a gray level value of the center cell (X_{N}) on the Nth line and each gray level values of cells (X_{N-}1, X_{N+}1) that are adjacent thereto in the horizontal direction, the first threshold value comparator 720 compares a mean value of the difference values with the first threshold value. Here, if a difference of gray level values is less than the first threshold value, there is a little or no difference of gray values between cells adjacent in the horizontal direction. Thus, a data driving unit performs identical or similar switching operations for the cells.

The second threshold value comparator 730 compares a difference between a gray level value of the center cell (X_{N}) that is less than the first threshold value judged by the first threshold value comparator 720 and a gray level value of a cell that is adjacent thereto in a vertical direction with a second threshold value. In other words, after the second threshold value comparator 730 evaluates a difference between a gray level value of the center cell (X_{N}) on the Nth line and a gray level value of a cell (X_{N+1}) that is adjacent thereto in the vertical direction, the first threshold value comparator 720 compares the difference value with the second threshold value. Here, if a difference of gray level values is more than the second threshold value, there is a large difference of gray values between cells adjacent in the vertical direction. Thus, a data driving unit performs different switching operations for each of the cells.

For example, if a gray level value of the center cell (X_{N}) on the Nth line is small and a gray level value of the cell on the N+1th line is big, the center cell (X_{N}) is mainly turned on in a sub-field being in charge of a low gray level and the cell (X_{N+1}) on the N+1th line is mainly turned on in a sub-field being in charge of a gray level that is not the low gray level. In other words, the center cell (X_{N}) on the Nth line is turned on and the cell (X_{N+1}) on the N+1th line is turned off in a sub-field being in charge of a low gray level, and the cells are conversely switched in a sub-field being in charge of a high gray level.

The third threshold value comparator 740 compares the number of the center cells with a third threshold value by evaluating the number of center cells that are less than the first threshold value and more than the second threshold value depending on a result judged by the first threshold value comparator 720 and a result judged by the second threshold value comparator 730. Therefore, if the number of center cells is more than the third threshold value in the wole picture during a frame, the corresponding frame is determined as an alternate pattern.

The pattern recognition information generator 750 determines an image signal of a frame as an alternate pattern when the number of center cells is more than the third threshold value. Thereafter, the pattern recognition information generator 750 generates alternate pattern recognition information and then transmits it to the controller 650.

FIG. 9 is a truth table illustrating a control operation of a contrller in a plasma display apparatus according to a first embodiment of the present invention.

Referring to FIG. 9, a data driver IC (Integrated Circuit; not shown) of a data driving unit is controlled during an address period in accordance with the truth table shown in FIG. 9. Particularly, a drive output state 920 is determined depending on a truth value of LBLK 910 controlled by a controller in a first embodiment of the present invention.

In other words, the controller controls a truth value of LBLK 910 to be “LOW” in an address period of a sub-field required to be cut off. Thus, since an output value of a data driver IC is “LOW”, an address pulse is not applied to an address electrode.

Further, a truth value is applied as “HIGH” in an address period used during a frame so that an address pulse is applied to an address electrode.

As described above, an alternate pattern is recognized by comparing gray level values of an input signal, and sub-fields used in accordance with this are reduced in a first embodiment of the present invention. Therefore, the number of switching times of an address driving unit is reduced, and damage of a sustain and a scan driving units can be prevented.

### SECOND EMBODIMENT

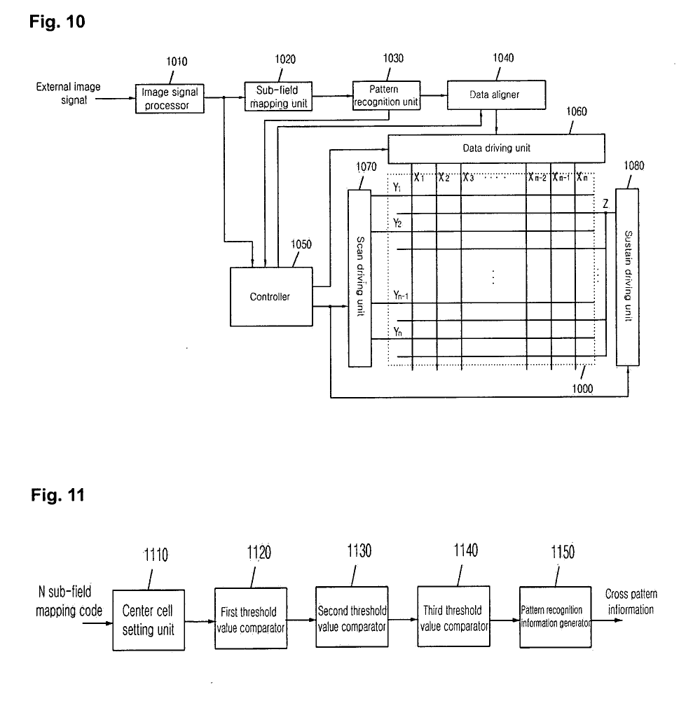

FIG. 10 is a schematic view illustrating a plasma display apparatus according to a second embodiment of the present invention.

As show in FIG. 10, the plasma display apparatus according to the second embodiment of the present invention includes a plasma display panel 1000, an image signal processor 1010, a sub-field mapping unit 1020, a pattern recognition unit 1030, a data aligner 1040, a controller 1050, a data driving unit 1060, a scan driving unit 1070 and a sustain driving unit 1080. Here, description of the plasma display panel 1000, the image signal processor 1010, the sub-field mapping unit 1020, the data aligner 1040, the controller 1050, the data driving unit 1060, the scan driving unit 1070 and the sustain driving unit 1080 will be omitted, since each of them has the same operation characteristics as each funtion unit of a plasma display apparatus shown in FIG. 6 according to the first embodiment of the present invention.

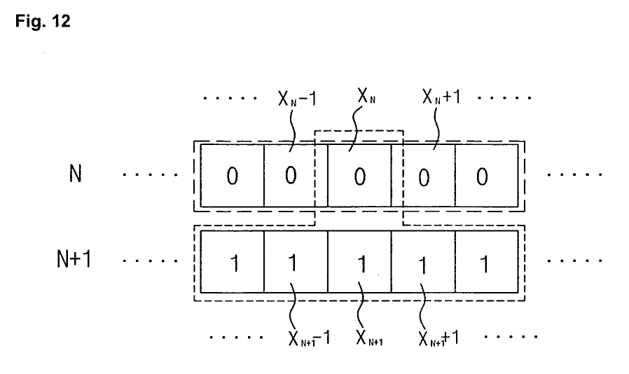

The pattern recognition unit 1030 according to the secod embodiment of the present invention is located at the back end of the sub-field mapping unit 1020. The pattern recognition unit 1030 recognizes an alternate pattern in which no less than a predetermined number of cells on the Nth line are turned on by comparing mapping codes of an image signal mapped in the sub-field mapping unit 1020 and no less than a predetermined number of cells on the N+1th line are turned off. In other words, the pattern recognition unit 1030 according to a second embodiment of the present invention judges an image signal displayed as an alternate pattern by comparing mapping codes of an image signal assigned to the whole cells in each sub-field. To this end, the pattern recognition unit 1030 sets a center cell and detects an alternate pattern by comparing the number of cells with a predetermined threshold value. This will be described in a more detailed manner with reference to FIGS. 11 and 12 hereafter.

The controller 1050 according to a second embodiment of the present invention contras sub-fields cut off not to be consecutive to each other and controls the number of sustain pulses applied in sub-fields using a predetermined number of sub-fields when an alternate pattern is expressed as described in the first embodiment of the present invention.

FIG. 11 is a schematic block diagram illustrating a pattern recognition unit according to a second embodiment of the present invention, and FIG. 12 is a view illustrating an operation characteristic of a pattern recognition unit according to a second embodiment of the present invention.

As shown in FIG. 11, the pattern recognition unit according to the second embodiment of the present invention includes a center cell setting unit 1110, a first threshold value comparator 1120, a second threshold value comparator 1130, a third threshold value comparator 1140 and a pattern recognition information generator 1150. An operation of the pattern recognition unit will be described with reference to FIGS. 11 and 12 together.

The center cell setting unit 1110 sets at least no less than two cells as center cells in one sub-field period. Contrary to the first embodiment of the present invention, the center cell setting unit 1110 sets arbitrary cells as a center cell for detecting an alternate pattern for the whole picture by the sub- field period unit in a second embodiment of the present invention. In other words, a cell (X_{N}) on the Nth line is set as a center cell.

The first threshold value comparator 1120 compares the number of cells having the same mapping codes as that of the center cell on the same line as that of the center cell with a first threshold value during the sub-field period. In other words, the first threshold value comparator 1120 evaluates the number of cells having the same mapping codes as that of the center cell (X_{N}) among cells ( . . . , XN−1, XN+1, . . . ) on the same line as that of the center cell (X_{N}) for the center cell (X_{N}) on the Nth line, and compares the number thereof with the first threshold value. Here, if the number of cells having the same mapping codes is more than the first threshold value during a corresponding sub-field period, switching elements of a data driving unit on the Nth line are approximately identically switched. At this time, the mapping code is a code having a value of “0” or “1” mapped by the sub-field unit to apply an address pulse.

The second threshold value comparator 1130 compares the number of cells having mapping codes different from that of the center cell on the next line of the center cell that is more than the first threshold value judged by the first threshold value comparator 1120 with a second threshold during the sub-field period. In other words, the first threshold value comparator 1120 evaluates the number of cells having mapping codes different from that of the center cell (X_{N}) among cells ( . . . , X_{N+1}−1, X_{N+1}+1, . . . ) on the N+1th line for the center cell (X_{N}) on the Nth line, and compares the number thereof with the second threshold value. Here, if the number of cells having mapping codes different from each other is more than the second threshold value during a corresponding sub-field period, switching elements of a data driving unit on the N+1th line and on the Nth line are approximately conversely switched to each other.

The third threshold value comparator 1140 evaluates the number of center cells that are more than the first and the second threshold values depending on a result judged by the first threshold value comparator 1120 and a result judged by the second threshold value comparator 1130, and compares the number thereof with a third threshold value. Therefore, if the number of center cells is more than the third threshold value in the wole picture during a frame, the corresponding sub-field is determined as an alternate pattern during a frame.

The pattern recognition information generator 1150 determines an image signal of the sub-field as an alternate pattern during a fram when the number of center cells is more than the third threshold value. Thereafter, the pattern recognition information generator 1150 generates alternate pattern recognition information and then transmits it to the controller 650.

As described above, a pattern recognition unit is located at the back end of a sub-field mapping unit and detects an alternate pattern by the sub-field unit in a second embodiment of the present invention, thereby detecting switching operations of a data driving unit more reliably than in the first embodiment of the present invention. Further, it is possible to effectively detect sub-fields used during one frame.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display apparatus comprising:
a pattern recognition unit for recognizing an alternate pattern in which no less than a predetermined number of cells on the Nth line are turned on and no less than a predetermined number of cells on the N+1th line are turned off depending on an image signal input from the exterior;
a sub-field mapping unit for mapping the image signal by the sub-field unit to a corresponding sub-field; and
a controller for controlling a predetermined number of sub-fields among the whole sub-fields during one frame to be used when the pattern recognition unit recognizes the alternate pattern.

2. The apparatus of claim 1, wherein the pattern recognition unit comprises:
a center cell setting unit for setting at least no less than two cells as center cells during one frame;
a first threshold comparator for comparing a difference between a gray level value of the center cell and a gray level value of a cell adjacent thereto in a horizontal direction with a first threshold value;
a second threshold comparator for comparing a difference between a gray level value of the center cell and a gray level value of a cell adjacent thereto in a vertical direction with a second threshold value;
a third threshold comparator for evaluating the number of center cells which are less than the first threshold value and more than the second threshold value, and comparing the number thereof with a third threshold value; and
a pattern recognition information generator for determining an image signal of the frame as an alternate pattern and generating alternate pattern recognition information when the number of the center cells is more than the third threshold value.

3. The apparatus of claim 2, wherein the first threshold value comparator compares the difference between the gray level value of the center cell and gray level values of at least no less than two cells adjacent thereto in a horizontal direction with the first threshold value.

4. A plasma display apparatus comprising:
a sub-field mapping unit for mapping an image signal input from the exterior by the sub-field unit to a corresponding sub-field;
a pattern recognition unit for recognizing an alternate pattern in which no less than a predetermined number of cells on the Nth line are turned on and no less than a predetermined number of cells on the N+1th line are turned off by comparing a mapping code of the mapped image signal; and
a controller for controlling a predetermined number of sub-fields among the whole sub-fields during one frame to be used when the pattern recognition unit recognizes the alternate pattern.

5. The apparatus of claim 4, wherein the pattern recognition unit comprises:
a center cell setting unit for setting at least no less than two cells as center cells during one sub-field period;
a first threshold comparator for comparing the number of cells having the same mapping codes as that of the center cell on the same line as that of the center cell with a first threshold value during the sub-field period;
a second threshold comparator for comparing the number of cells having mapping codes different from that of the center cell on the next line of the center cell with a second threshold value during the sub-field period;
a third threshold comparator for evaluating the number of center cells which are more than the first threshold value and the second threshold value and comparing the number thereof with a third threshold value; and
a pattern recognition information generator for determining an image signal of the frame as an alternate pattern during one frame and generating alternate pattern recognition information when the number of the center cells is more than the third threshold value.

6. The apparatus of claim 4, further comprising:
a data aligner for realigning by the sub-field an image signal mapped to the sub-field; and
a data driving unit for applying an address pulse corresponding to the aligned image signal to an address electrode under control of the controller.

7. The apparatus of claim 6, wherein the controller controls sub-fields cut off when the alternate pattern is recognized to be selected, and controls a cutoff signal for turning off a switching element of the data driving unit during an address period of the selected sub-field to be applied to the data driving unit.

8. The apparatus of claim 7, wherein the controller controls the sub-fields cut off not to be consecutive to each other.

9. The apparatus of claim 6, wherein the controller controls the number of sustain pulses applied depending on sub-fields used during one frame.

10. A method of driving a plasma display apparatus comprising the steps of:
recognizing an alternate pattern in which no less than a predetermined number of cells on the Nth line are turned on and no less than a predetermined number of cells on the N+lth line are turned off depending on an image signal input from the exterior;
mapping the image signal by the sub-field unit to a corresponding sub-field; and
controlling a predetermined number of sub-fields among the whole sub-fields during one frame to be used when the alternate pattern is recognized in the pattern recognition step.

11. The method of claim 10, wherein the pattern recognition step comprises the steps of:
setting at least no less than two cells as center cells during one frame;
comparing a difference between a gray level value of the center cell and a gray level value of a cell adjacent thereto in a horizontal direction with a first threshold value;
comparing a difference between a gray level value of the center cell and a gray level value of a cell adjacent thereto in a vertical direction with a second threshold value;
evaluating the number of center cells which are less than the first threshold value and more than the second threshold value and comparing the number thereof with a third threshold value; and
determining an image signal of the frame as an alternate pattern and generating alternate pattern recognition information when the number of the center cells is more than the third threshold value.

12. The method of claim 11, wherein the difference between the gray level value of the center cell and gray level values of at least no less than two cells adjacent thereto in a horizontal direction are compared with the first threshold in the first threshold value comparing step.

13. A method of driving a plasma display apparatus comprising the steps of:
mapping an image signal input from the exterior by the sub-field unit to a corresponding sub-field;
recognizing an alternate pattern in which no less than a predetermined number of cells on the Nth line are turned on and no less than a predetermined number of cells on the N+lth line are turned off by comparing a mapping code of the mapped image signal; and
controlling a predetermined number of sub-fields among the whole sub-fields during one frame to be used when the alternate pattern is recognized in the pattern recognition step.

14. The method of claim 13, wherein the pattern recognition step comprises the steps of:
setting at least no less than two cells as center cells during one sub-field period;
comparing the number of cells having the same mapping codes as that of the center cell on the same line as that of the center cell with a first threshold value during the sub-field period;
comparing the number of cells having mapping codes different from that of the center cell on the next line of the center cell with a second threshold value during the sub-field period;
evaluating the number of center cells which are more than the first threshold value and the second threshold value and comparing the number thereof with a third threshold value; and
determining an image signal of the frame as an alternate pattern during one frame and generating alternate pattern recognition information when the number of the center cells is more than the third threshold value.

15. The method of claim 13, further comprising the steps of:
realigning by the sub-field an image signal mapped to the sub-field; and
applying an address pulse corresponding to the aligned image signal to an address electrode under control of the controller.

16. The method of claim 15, wherein sub-fields cut off are selected when the alternate pattern is recognized, and a cutoff signal for turning off a switching element of the data driving unit during an address period of the selected sub-field is applied to the data driving step in the control step.

17. The method of claim 16, wherein the sub-fields cut off are not consecutive to each other in the control step.

18. The method of claim 15, wherein the number of sustain pulses applied depending on sub-fields used during one frame is controlled in the control step.

19. The apparatus of claim 1, further comprising:
a data aligner for realigning by the sub-field an image signal mapped to the sub-field; and
a data driving unit for applying an address pulse corresponding to the aligned image signal to an address electrode under control of the controller.

20. The method of claim 10, further comprising the steps of:
realigning by the sub-field an image signal mapped to the sub-field; and
applying an address pulse corresponding to the aligned image signal to an address electrode under control of the controller.
